(19) United States
(12) Patent Application Publication
(10) Pub. No.: US 2010/0154474 A1
(43) Pub. Date: Jun. 24, 2010

(54) REDUCED STRIAE LOW EXPANSION GLASS AND ELEMENTS, AND A METHOD FOR MAKING SAME

(76) Inventors: Lorrie Foley Beall, Painted Post, NY (US); John Edward Maxon, Canton, NY (US); William Rogers Rosch, Corning, NY (US); Robert Sabia, Corning, NY (US)

Correspondence Address: CORNING INCORPORATED, SP-TI-3-1, CORNING, NY, 14831, US

(21) Appl. No.: 12/688,218

(22) Filed: Jan. 15, 2010

Related U.S. Application Data
(63) Continuation-in-part of application No. 11/445,071, filed on May 31, 2006, now abandoned.
(60) Provisional application No. 60/753,058, filed on Dec. 21, 2005.

(51) Int. Cl. C03B 19/06; C03B 19/00

(52) U.S. Cl. 65/17.4; 65/17.5

(57) ABSTRACT

The invention is directed to a method for reducing striae in ultra-low expansion glass, for example, silica-titania glass, by heat-treating the glass at temperatures above 1600° C. for a time in the range of 72-288 hours. The silica-titania glass is formed by substantially simultaneously forming, collecting and consolidating a silica-titania soot formed in one or a plurality of burners using silicon-containing feedstock and a titanium-containing feedstock. In one embodiment of the invention the glass is heat treated without forcing the glass to flow or “move”. The invention was found to reduce the magnitude of striae in an ultra-low expansion glass by at least 50%, and particularly reduces most of the “higher frequency” striae.

### PRIORITY

This application is a Continuation-in-Part claiming the priority of U.S. patent application Ser. No. 11/445,071 filed May 31, 2006, which in turn claims the priority of U.S. Provisional Application No. 60/753,058, filed Dec. 21, 2005, and the application being titled “REDUCED STRIAE LOW EXPANSION GLASS AND ELEMENTS, AND METHOD FOR MAKING SAME.”

This invention relates to extreme ultraviolet elements made from glasses including silica and titania. In particular, the invention relates to a low expansion glass and elements made therefrom that have reduced striae, and to a method for making such glass and elements which are suitable for extreme ultraviolet lithography.

### BACKGROUND OF THE INVENTION

Ultra low expansion glasses and soft x-ray or extreme ultraviolet (EUV) lithographic elements made from silica and titania traditionally have been made by flame hydrolysis of organometallic precursors of silica and titania. Ultra-low expansion silica-titania articles of glass made by the flame hydrolysis method are used in the manufacture of elements used in mirrors for telescopes used in space exploration and extreme ultraviolet or soft x-ray-based lithography. These lithography elements are used with extreme ultraviolet or soft x-ray radiation to illuminate, project and reduce pattern images that are utilized to form integrated circuit patterns. The use of extreme ultraviolet or soft x-ray radiation is beneficial in that smaller integrated circuit features can be achieved. However, the manipulation and direction of radiation in this wavelength range is difficult. Accordingly, wavelengths in the extreme ultraviolet or soft x-ray range, such as in the 1 nm to 70 nm range, have not been widely used in commercial applications. One of the limitations in this area has been the inability to economically manufacture mirror elements that can withstand exposure to such radiation while maintaining a stable and high quality circuit pattern image. Thus, there is a need for stable high quality glass lithographic elements for use with extreme ultraviolet or soft x-ray radiation.

One limitation of ultra low expansion titania-silica glass made in accordance with the method described above is that the glass contains striae. Striae are compositional inhomogeneities which adversely affect optical transmission in lens and window elements made from the glass. Striae can be measured by a microprobe that measures compositional variations that correlate to coefficient of thermal expansion (CTE) variations of a few ppb/° C. In some cases, striae have been found to impact surface finish at an angstrom root mean rms level in reflective optic elements made from the glass. Extreme ultraviolet lithographic elements require finishes having a very low rms level.

It would be advantageous to provide improved methods and apparatus for manufacturing ultra low expansion glasses containing silica and titania. In particular, it would be desirable to provide extreme ultraviolet elements having reduced striae and methods and apparatus that are capable of producing such glass elements. In addition, it would be desirable to provide improved methods and apparatus for measuring striae in ultra low expansion glass and extreme ultraviolet lithographic elements.

### SUMMARY OF THE INVENTION

The invention in one embodiment is directed to a method of reducing striae in low expansion glass by substantially simultaneous formation, deposition and consolidation of a silica-titania soot formed in a burner into a glass boule followed by heat treating the glass at temperatures from approximately 100° C. above the annealing point of the glass to temperatures used for rapid flowout (approximately 1900° C.) for a time in the range of 6+ hours to 12 months depending on the temperature. As used herein the phrase “substantially simultaneous formation, deposition and consolidation of a silica-titania soot formed in a burner” means that the silica-titania soot, after being formed in the burner, exits the burners into a furnace atmosphere that is at a temperature sufficient to consolidate the soot as it is collected in a vessel or on a collecting surface. The time for substantially simultaneous formation, deposition and consolidation is less than 2 seconds. The soot can be formed using one or a plurality of burners.

The invention is also directed to an ultra-low expansion glass and optical elements made therefrom that are suitable for extreme ultraviolet lithography, and to a method for making such glass and elements by reducing striae in ultra-low expansion glass by heat-treating the glass at temperatures above 1400° C. for a minimum of 24 hours. In a preferred embodiment the glass is heat treated at temperatures above 1600° C. for a time in the range of 72-288 hours. In yet another embodiment the glass is heat treated without forcing the glass to flow or “move”.

A further embodiment of the invention is directed to a method for reducing striae in an ultra-low expansion silica-titania glass, and to optical elements made therefrom, in which a silica-titania consolidated glass boule is prepared in a rotating vessel in a furnace at consolidation temperatures by forming a silica-titania soot in a burner by combustion of a mixture of a selected titanium compound and a selected silicon compound accompanied by the substantially simultaneous deposition and consolidation of the formed silica-titania to form the consolidated glass boule; heat treating the consolidated glass boule at a temperature in the range of 1600-1700° C. for a time in the range of 72-288 hours, and cooling the consolidated boule from the 1600-1700° C. range to 1000° C. at a rate in the range of 25-75° C. per hour, preferably at a rate of 50° C. per hour, followed by cooling to ambient temperature at the natural cooling rate of the furnace to thereby yield a silica-titania glass boule having reduced striae. In an embodiment of this invention the glass boule is prepared by flame hydrolysis using silica and titania precursors selected from the group consisting of siloxanes and alkoxides and tetrachlorides of silicon and titanium. The preferred precursors are titanium isopropoxide and octamethylcyclotetrasiloxane.

In another embodiment the invention is directed to heat-treating a low expansion glass at a temperature in the range of 1600-1700° C. for a time in the range of 72-288 hours without forcing the glass to flow or “move”.

In a further embodiment the invention is directed to a method of reducing striae in a large boule of glass or in a segment of glass obtained from a large boule by heat treating a glass boule at a temperature in the range of 1600-1700° C. for a time in the range of 72-288 hours without forcing the glass to flow or “move”; and during the heat treatment the glass is rotated about an vertical axis, and the heat source is uniformly distributed across the horizontal dimensions of the glass. In a further preferred embodiment glass is heat treated at a temperature in the range of 1600-1700° C. for a time in the range of 72-160 hours without forcing the glass to flow or “move”; and during the heat treatment the glass is rotated about an vertical axis, and the heat source is uniformly distributed across the horizontal dimensions of the glass.

In yet another embodiment the invention is directed to reducing striae in a silica-titania glass containing 5-10 weight percent titania.

In an additional embodiment the invention is directed to reducing striae in low expansion glass without forcing the glass to flow by placing the glass in a vessel and placing a packing material between the glass and the vessel, and then heat treating the glass at a temperature greater than 1600° C. for a time in the range of 72-288 hours.

In a further embodiment the disclosure is directed to a method of reducing striae in a silica-titania glass, the method comprising the steps of supplying a silicon-containing feedstock and a titanium-containing feedstock to at least one burner and combusting the feed stocks to form a silica-titania soot, and substantially simultaneously, collecting the silica-titania soot in a collection vessel at consolidation temperatures to thereby form a silica-titania glass as the soot is deposited in the vessel; continuing the collection and consolidations of the Silica-titania soot to form a glass boule if selected dimensions; after collections and consolidation are completed, in a separate step heat treating the glass in a furnace at a temperature greater than 1600° C. for a time in the range of 72-288 hours; and cooling the glass to ambient temperature to yield a silica-titania glass having reduced striae. In one embodiment the heat-treating time can be in the range of 72-160 hours.

In another embodiment the disclosure is directed to an optical element having reduced striae, the optical elements being made by the method comprising the steps of supplying a silicon-containing feed stock and a titanium-containing feedstock to burner and combusting the feedstocks to form a silica-titania soot and, substantially simultaneously, collecting the silica-titania soot in a collection vessel at consolidation temperatures to thereby form a silica-titania glass as the soot is deposited in the vessel; continuing the collection and consolidation of the silica-titania soot to form a glass boule of selected dimensions; and after collection and consolidation is completed, in a separate step heat treating the glass in a furnace at a temperature greater than 1600° C. for a time in the range of 72-160±8 hours; cooling the boule to ambient temperature; processing the boule or segments thereof into the shape of a selected optical element; and cutting, grinding and polishing the shape into an optical element having reduced striae suitable for extreme ultraviolet lithography. In a further embodiment, after the silica-titania glass has been consolidated into the boule, the boule is cooled o ambient temperature and processed by cutting and/or sawing to form an optical element blank. The optical blank is then heat treated at 1600° C. for a time in the range of 72-160±8 hours; cooled to ambient temperature and further process by, for example, grinding and polishing.

The disclosure is further directed to a silica-titania glass boule formed by the method comprising of supplying a silica-containing feedstock and titania-containing feedstock to at least one burner and combusting the feed stocks to form a silica-titania soot, and, substantially simultaneously, collecting the silica-titania soot in a collection vessel at consolidation temperatures to thereby form a silica-titania glass as the soot is deposited in the vessel; continuing the collection and consolidation of the silica-titania soot to form a boule of selected dimensions; after collection and consolidation is completed, in a separate step heat treating the glass in a furnace at a temperature greater than 1600° C. for a time in the range of 72-288 hours; and cooling the glass to ambient temperature to yield silica-titania glass boule having reduced striae. In one embodiment the separate heat treatment is carried out in the same furnace after collections of the soot and its consolidation into a boule is completed. In another embodiment the boule is formed and cooled to ambient temperature, or a temperature within 200° C. of ambient temperature, and the boule is given the separate heat treatment at a temperature greater than 1600° C. for a time in the range of 72-288 hours in a further other than that in which the boule was formed. In an additional embodiment, the

### BRIEF DESCRIPTION OF THE DRAWINGS

FIG. 1 is an illustration of a prior art apparatus that can be used for manufacturing silica-titania ultra low expansion glasses.

FIGS. 2A and 2B illustrate interferometric data depicting the impact of striae on mid-frequency surface roughness before and after, respectively, heat treatment according to the invention, respectively.

FIGS. 3A and 3B depict the birefringence magnitude due to striae on the y-axis versus the position on the boule (x-axis) before and after, respectively, heat treatment according to the invention, respectively.

FIG. 4 illustrates the magnitude of striae reduction near the top of a boule before and after heat treatment according to the invention.

FIG. 5 is an illustration of CTE changes versus location in a boule before and after the boule has been heat treated according to the invention.

FIG. 6 is a graph illustrating a wide range of times and temperatures at which the invention can be practiced.

### DETAILED DESCRIPTION OF THE INVENTION

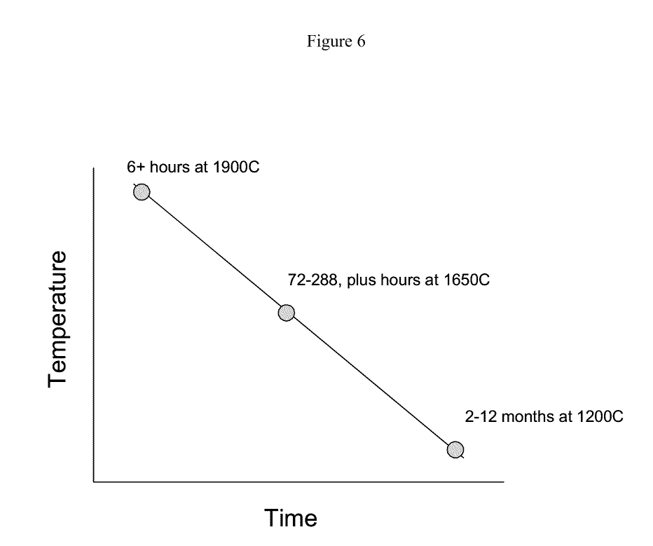

Overall, the invention is directed to a method of reducing striae in low expansion glass by heat treating the glass at temperatures from approximately 100° C. above the annealing point of the glass (approximately 1200° C.) to temperatures used for rapid flowout (approximately 1900° C.) for a time in the range of 6+ hours to 12 months depending on the temperature. FIG. 6 is a generic graph illustrating the extreme and most useful (median) times and temperatures that can be used in practicing the invention. Generally, the glass is heat treated at temperatures above 1400° C. for a time greater than 24 hours. For most silica-titania glass compositions the practical (commercially desirable) times and temperatures are 72-288+ hours at a temperature in the range of 1600-1700° C. (the median temperature being 1650° C.). At lower temperatures the required time will be extensive, but the results are expected to be similar to that obtained at the practical times/temperatures.

U.S. Pat. No. 5,970,751, which describes a method and apparatus for preparing fused silica-titania glass. The apparatus includes a stationary cup or vessel. U.S. Pat. No. 5,696,038 describes using oscillation/rotation patterns for improving off-axis homogeneity in fused silica boules using a prior art rotating cup as described therein. As disclosed in U.S. Pat. No. 5,696,038, the x-axis and y-axis oscillation patterns were defined by the equations:

x(t)=r₁ sin 2 πω₁t+r₂ sin 2 πω₂t

y(t)=r₁ cos 2 πω₁t+r₂ cos 2 πω₂t

where x(t) and y(t) represent the coordinates of the center of the boule as measured from the center of the furnace ringwall as a function of time (t) measured in minutes. The sum of r₁ and r₂ must be less than the difference between the radius of the ringwall and radius of the containment vessel or cup to avoid contact between these structures during formation of the boule. The parameters r₁, r₂, ω₁, ω₂, and a fifth parameter, ω₃, which represents the boule's rotation rate about its center in revolutions per minute (rpm) define the total motion of the boule. Generally, when practicing the present invention the values for ω₁, ω₂ and ω₃ are in the range of 1.6-1.8, 3.5-3.7 and 4.0-4.2, respectively. The values for ω₁, ω₂ and ω₃ used herein in the manufacture of titania-containing silica boules are 1.71018 rpm, 3.63418 rpm and 4.162 rpm, respectively as described in U.S. application Ser. No. 10/378,391, published as U.S. Patent Application Publication 2004/0027555 A1, which is commonly owned with the present application by Corning Incorporated.

U.S. Patent Application Publication No. 2004/0027555 describes a method for producing low expansion, titania-containing silica glass bodies by depositing titania-containing glass soot. The method in U.S. 2004/0027555 uses the apparatus described in U.S. Pat. No. 5,970,751, and the rotating/oscillating cup described in U.S. Pat. No. 5,696,038. Silica-titania soot is deposited in a vessel mounted on an oscillating table and the striae level is reduced by altering the oscillation pattern of the table, particularly by increasing the rotation rate of the table. In particular, U.S. 2004/0027555 states that it was found that increasing the values for each of ω₁, ω₂, and ω₃ reduces striae values. Publication 2004/0027555 describes other factors that impact striae and steps that can be taken to counteract the striae formation by controlling exhaust flow. For example, it describes the determination that the flows through the exhaust ports or vents of the furnace impact striae and that striae could be lessened by increasing the number of vents or exhaust ports. Also see U.S. Pat. Nos. 5,951,730 and 5,698,484 for additional information concerning boule formation.

While the foregoing improvements decreased striae, further reduction of striae is highly desired. Further reducing striae in a boule of silica-titania ULE glass, or in a segment of glass obtained from a boule, will reduce some of the polishing issues which have been observed with ULE materials. Specifically, mid-spatial frequency surface roughness will be improved and this will result in a material more suitable for EUV applications and other applications where an extremely smooth surface finish is required. Striae (or composition layering) in ULE glass is very evident in the direction parallel with the top and bottom of the boules. The striae consists of variations in titania (TiO₂) composition of generally more than ±0.1% compared to the local average TiO₂ level; which levels are frequently in the 7.25 to 8.25 wt. % range (though they can be higher or lower, and are typically in the range of 5-10 wt % TiO₂) depending on nominal CTE target. Variations in composition (striae) result in alternating thin layers of different CTE and therefore alternating planes of compression and tension (between the layers). When attempting to polish such ULE glass material, the alternating compression and tension layers caused by striae result in unequal material removal and unacceptable surface roughness. This effect has been observed in the mirror industry, where the mid-spatial frequency surface roughness defect is commonly referred to as “woodgrain”. Reducing striae, the composition variation, by methods such as described herein will reduce the level of compression and tension between the layers resulting in improved polishability.

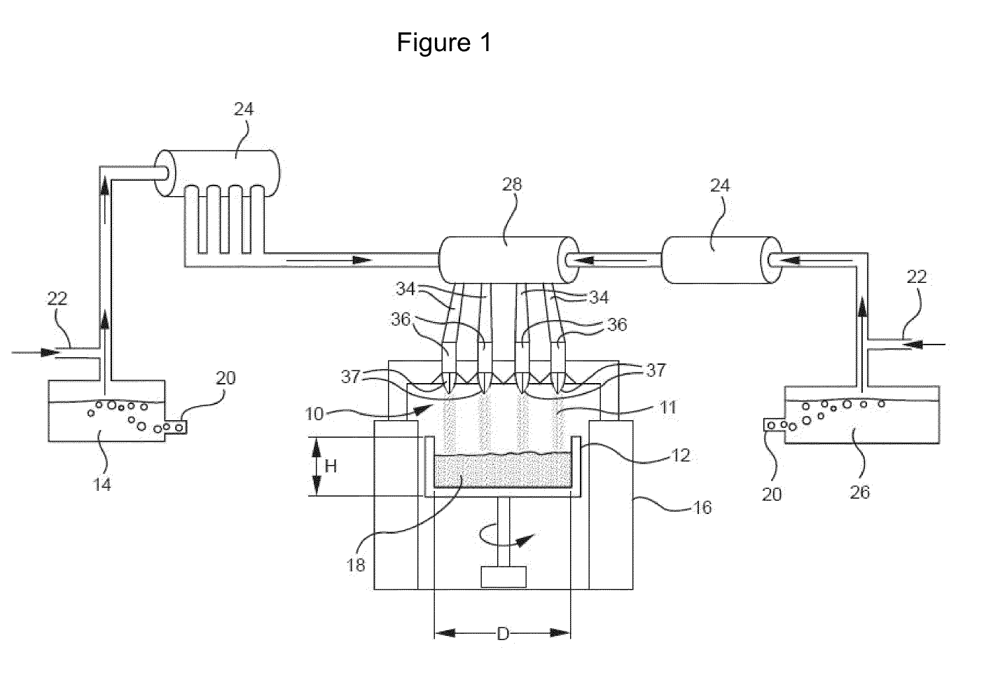

As a first step, a silica-titania glass boule is prepared according to any method known in the art; for example, by the method described in U.S. Pat. No. 5,696,038 using the apparatus as described in Application Publication No. 2004/0027555, which apparatus is illustrated herein as FIG. 1, with the inclusion of the provision that the formation of the silica-titania soot and its collection in a vessel and consolidation into a glass boule are substantially simultaneous as has been indicated herein. That is, the temperature within apparatus is sufficient so that as the soot, as it collected in a vessel, is being formed into a glass boule and does not remain as a soot. The ω₁, ω₂ and ω₃ values used in the manufacture of titania-containing silica boules described herein are 1.71018 rpm, 3.63418 rpm and 4.162 rpm, respectively. In accordance with the invention, after the boule was manufactured, striae were reduced in a separate step heat treating step by holding the silica-titania ULE glass boule at a temperature in excess of 1600° C. (as indicated by the furnace crown temperature) for a time in the range of 72-160±8 hours, preferably 72-96±8 hours (approximately 3-4 days). In one embodiment the temperature was in the range of 1600-1700° C. In a further embodiment the temperature was approximately 1650±25° C. In another embodiment the glass was held at temperature in a manner such that the glass does not mix or move, although movement of the glass is not expected to diminish the striae reduction according to the invention. The motion restriction of the glass was accomplished by packing the material with refractory in such a way that the glass could not move in any direction. After packing to restrict movement, the glass was heated using standard CH₄-Oxy fired burners in the same furnaces used to make the silica-titania ULE boule. Glass surface temperature data was recorded during the heat treatments (shown below). After the temperature hold for a time as indicated above, the glass was force-cooled at a rate of approximately 50° C. per hour down to 1000° C. and then allowed to cool at furnace cooling rate to ambient temperature (the temperature of the room surrounding the furnace). The burners were arranged so that they covered all radii of the glass sample being heated and the gas flows to the burners were sufficient to achieve and maintain the temperatures specified herein.

After the boule formed (soot formation, consolidation and consolidation), and after having striae reduced by heat treating as described above, and after it has been cooled to ambient temperatures, the boule can be cut, cored or otherwise processed into shapes that are suitable for making optical elements. Such processing, in addition to cutting or coring, may include etching, additional thermal treatments, grinding, polishing, applying selected metals to form a mirror, and such additional processing as may be necessary to form the desired optical element.

A general method for making silica-titania optical elements having reduced striae is to prepare a silica-titania glass boule in a furnace using any method known in the art, with the inclusion of the provision that the formation of the silica-titania soot and its collection in a vessel and consolidation into a glass boule are substantially simultaneous. That is, the temperature within apparatus is sufficient so that as the formed soot is collected in a vessel and consolidated into a glass boule and does not remain as soot. After boule formation is complete, in a separate step the boule is heat treated at a temperature above 1600° C. for a time in the range of 72-288 hours (preferably at a temperature in the range of 1600-1700° C., for a time in the range of 72-160) to reduce the striae in said boule, followed by cooling the boule from the above 1600° C. range to 1000° C. at a rate of 50° C. per hour followed by cooling to ambient temperature at the natural cooling rate of the furnace to thereby yield a silica-titania glass boule having reduced striae; and processing the glass as necessary into a reduced striae optical element. In one embodiment, after the consolidated boule has been formed, the boule can be cooled as indicated and the heat treating can be carried out at a later time in a heat treating furnace under the same conditions.

A particular embodiment for making silica-titania optical elements having reduced striae is to prepare a silica-titania consolidated glass boule in a rotating vessel in a furnace using any method known in the art, with the inclusion of the provision that the formation of silica-titania soot and its collection in a vessel and consolidation into a glass boule are substantially simultaneous. That is, the temperature with apparatus is sufficient so that as the soot it collected in a vessel it is being formed into a glass boule and does not remain as soot. In a separate step after consolidation is completed, heat treating the boule (or a sample taken from a boule so prepared but not heat treated) at a temperature in the range of 1600-1700° C. for a time in the range of 72-288 hours to reduce the striae in said boule; cooling the boule (or sample) from the 1600-1700° C. range to 1000° C. at a rate of 50° C. per hour followed by cooling to ambient temperature at the natural cooling rate of the furnace to thereby yield a silica-titania glass boule (or sample) having reduced striae. After the entire boule has been heat treated and cooled, it can be processed into the shape of a selected optical element or optical element blank; and then further processed by cutting, grinding and polishing the shape into an optical element having reduced striae suitable for extreme ultraviolet lithography. The optical elements thus made are suitable for extreme ultraviolet lithography; for example, mirrors for use in reflective lithography methods.

### Example 1

Referring to the apparatus described in FIG. 1 herein, a titania-containing silica glass boule was manufactured using a high purity silicon-containing feedstock or precursor 14 and a high purity titanium-containing feedstock or precursor 26. The feedstock or precursor materials are typically siloxanes, alkoxides and tetrachlorides containing titanium or silicon. Siloxanes and alkoxides of silicon and titanium are preferred. One particular commonly used silicon-containing feedstock material is octamethylcyclotetrasiloxane, and one particular commonly used titanium-containing feedstock material is titanium isopropoxide, both of which were used herein. An inert bubbler gas 20 such as nitrogen was bubbled through feedstocks 14 and 26, to produce mixtures containing the feedstock vapors and carrier gas. An inert carrier gas 22 such as nitrogen was combined with the silicon feedstock vapor and bubbler gas mixture and with the titanium feedstock vapor and bubbler gas mixture to prevent saturation and to deliver the feedstock materials 14, 26 to a conversion site 10 within furnace 16 through distribution systems 24 and manifold 28. The silicon feedstock and vapor and the titanium feedstock and vapor were mixed in a manifold 28 to form a vaporous, titanium-containing silica glass precursor mixture which was delivered through conduits 34 to burners 36 mounted in the upper portion 38 of the furnace 16. The burners 36 produce burner flames 37. Conversion site burner flames 37 are formed with a fuel and oxygen mixture such as methane mixed with hydrogen and/or oxygen, which combusts, oxidizes and converts the feedstocks at temperatures greater than about 1600° C. into soot 11. The burner flames 37 also provide heat to consolidate the soot 11 into glass. The temperature of the conduits 34 and the feedstocks contained in the conduits are typically controlled and monitored in minimize the possibility of reactions prior to the flames 37.

The feedstocks were delivered to a conversion site 10, where they were converted into titania-containing silica soot particles 11. The soot 11 was deposited in a revolving collection cup 12 located in a refractory furnace 16 typically made from zircon and onto the upper glass surface of a hot titania-silica glass body 18 inside the furnace 16. The temperature within the furnace and the collection cup is such that as the soot is collected in the cup it is consolidated into a glass boule. The values for ω₁, ω₂ and ω₃ used in the manufacture of the titania-containing silica boules were 1.71018 rpm, 3.63418 rpm and 4.162 rpm, respectively. The soot particles 11 consolidate into a titania-containing high purity silica glass body.

The cup 12 typically has a circular diameter shape of between about 0.2 meters and 2 meters so that the glass body 18 is a cylindrical body having a diameter D between about 0.2 and 2 meters and a height H between about 2 cm and 20 cm. The weight percent of titania in the fused silica glass can be adjusted by changing the amount of either the titanium feedstock or silicon-containing feedstock delivered to the conversion site 10 where it is substantially simultaneously formed into the soot 11, deposited in the collection vessel or cup 12 and consolidated into the glass 18. The amount of titania and/or silica is adjusted so that the glass body has a coefficient of thermal expansion of about zero at the operating temperature of an EUV or soft x-ray reflective lithography or mirror element.

The soot or powder formed in the burner is collected in the cup and consolidated into a glass boule as the soot or powder is collected in the cup. Typically, temperatures above 1600° C. are sufficient to consolidate the powder into a glass boule as the powder is deposited; for example without limitation, a temperature in the range 1645-1655° C. After the silica-titania glass boule of the desired size was formed, the glass boule was removed from the furnace for further processing in accordance with the present invention. Formation and consolidation of a boule approximately 60 inches (approximately 150 cm) in diameter and approximately 6 inches (approximately 15 cm) thick (the vertical thickness of the glass as made) is typically done over a time in the range of 160 to 200 hours. One can also prepare smaller boules approximately 4-6 inches (approximately 1-15 cm) in diameter and 1-2 inches (2.5-5 cm) thick (the vertical thickness of the glass as made) which can be made and consolidated over a shorter time period of approximately 16-48 hours. When the boule is removed from the furnace, either the entire boule can be returned to the furnace for heat treating processing according to the invention or a segment of the boule can be cored. The cores are taken through the depth of the boule and were heat treated according to the invention to reduce striae. In yet another embodiment, after the boule is formed and consolidated at a temperature above 1600° C. as described herein, the consolidated boule is then heat treated in a further step in accordance with the invention by maintaining the temperature of the boule in the range of 1600-1700° C. for an additional time in the range of 72-288 hours without removing the boule from the furnace. After the additional heat treatment and cooling, the boule can then be processed into optical elements.

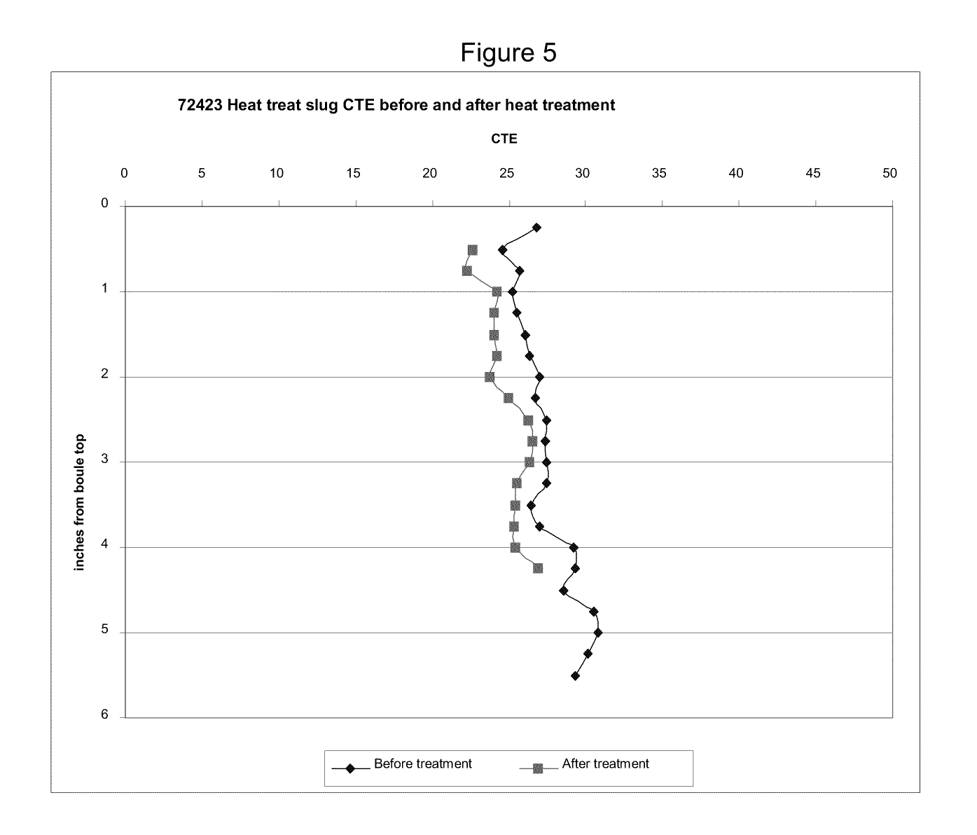

In the present example multiple 25.4 cm (10 inch) diameter silica-titania cores were taken of approximately the entire thickness of a large 60 inch boule formed by the substantially simultaneous deposition and consolidation of silica-titania soot as has be described above and cooled without heat treating. For heat-treating according to the invention, a silica-titania glass core was placed in a zircon (zirconium silicate) cup or vessel, and the core was surrounded on its edge and bottom with crushed zircon to restrict movement of the glass. The core and cup were then placed in a rotating furnace and heated to a temperature a temperature in the range of 1600-1700° C. for a time in the range of 72-288 hours. The glass sample was heated using CH₄-Oxy burners and glass surface temperatures were recorded during the heat treatment. After the glass was held at temperature for the indicated time range, the glass was cooled in the furnace at a rate of approximately 50° C./hour down to a temperature of approximately 1000° C., and then to ambient temperature at the natural cooling rate of the furnace. After final cooling the samples were annealed at a temperature below 1000° C. for a time in the range of 70 to 130 hours and, after cooling after annealing, CTE (coefficient of thermal expansion) measurements were recorded in 0.635 cm (one-quarter inch) increments using PEO equipment. The data indicate that the bulk CTE value is not negatively affected by heat treatment according to the invention, and in fact, as is illustrated in the point-by-point comparison in FIG. 5, was reduced by the heat treatment.

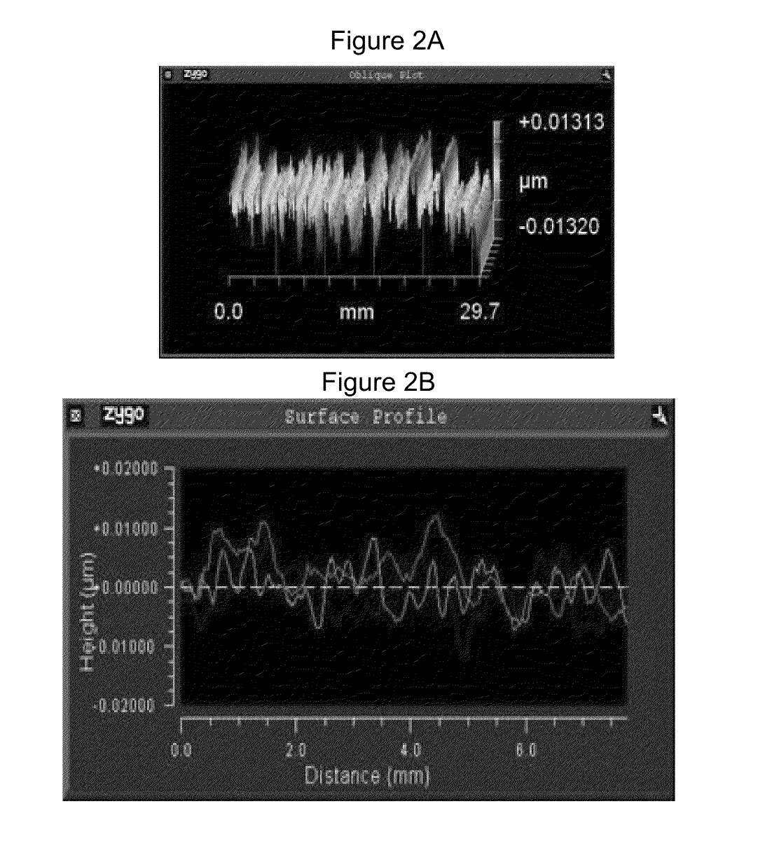

FIGS. 2A and 2B are interferometric scans. FIG. 2A is an interferometric scan depicting the impact of striae on mid-spatial frequency roughness. Due to the waviness of striae throughout the boule, it is not possible to extract a part with striae that are perfectly parallel with the boule' surface. Consequently, some striae always “break” the surface. FIG. 2B is an interferometric scan across striae and shows the peak-to-valley changes in the surface. Striae improvements were determined by analysis of improvements in optical retardation.

The division of light into two components (an “ordinary” ray nₒ and an extraordinary ray nₑ) is found in materials which have two different indices of refraction in different directions such that when light entering certain transparent material, it splits into two beams which travel at different speeds through the material (a faster path and a slower path). Optical retardation is defined by the equation Δn=nₑ−nₒ, where nₒ and nₑ are the refractive indices for polarizations perpendicular and parallel to the axis of anisotropy, respectively. Consequently, when the beam exits the material there is a difference between when the faster and the slower beam exit. This difference is the optical retardation, commonly measure in nanometers. Optical retardation is scaled by the thickness of the material through which the light passes. If one sample of a material is twice as thick as a second sample of the same material, the sample that is twice as thick will exhibit twice the optical retardation of the other sample. Because optical retardation scales with thickness it is often normalized by dividing by the sample thickness (in centimeters [“cm”]). This normalized optical retardation is known as birefringence. The difference between birefringence and retardation is that birefringence is normalized.

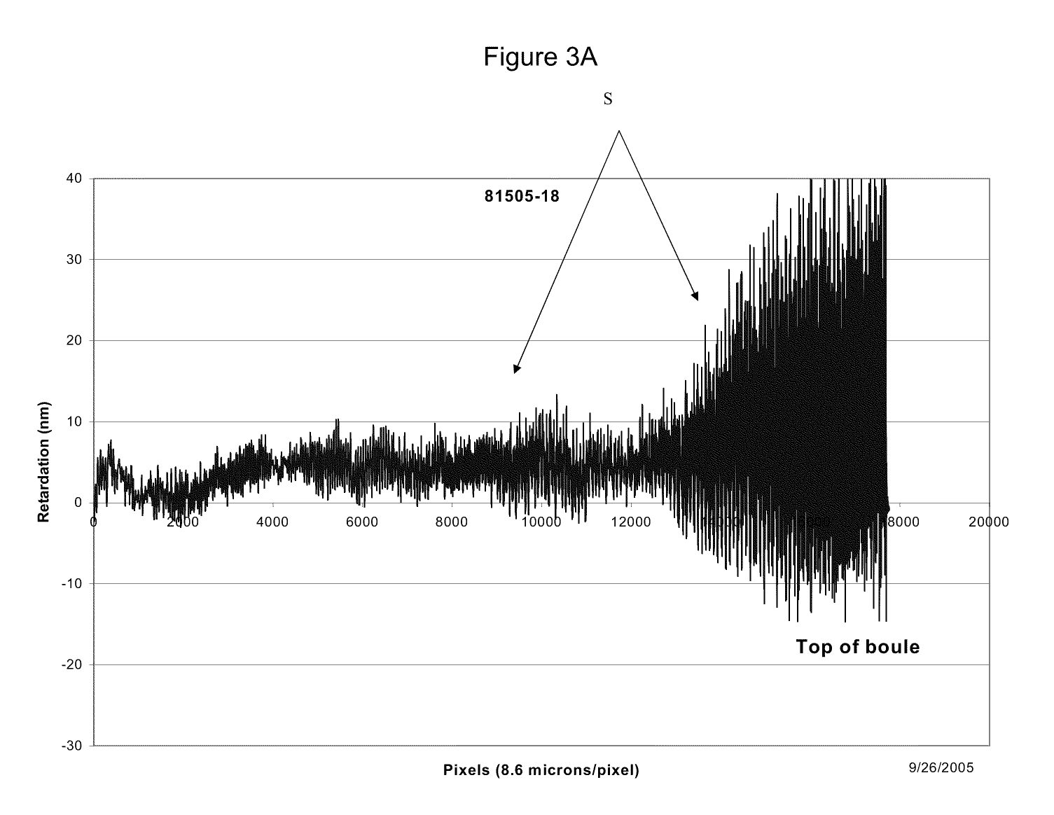

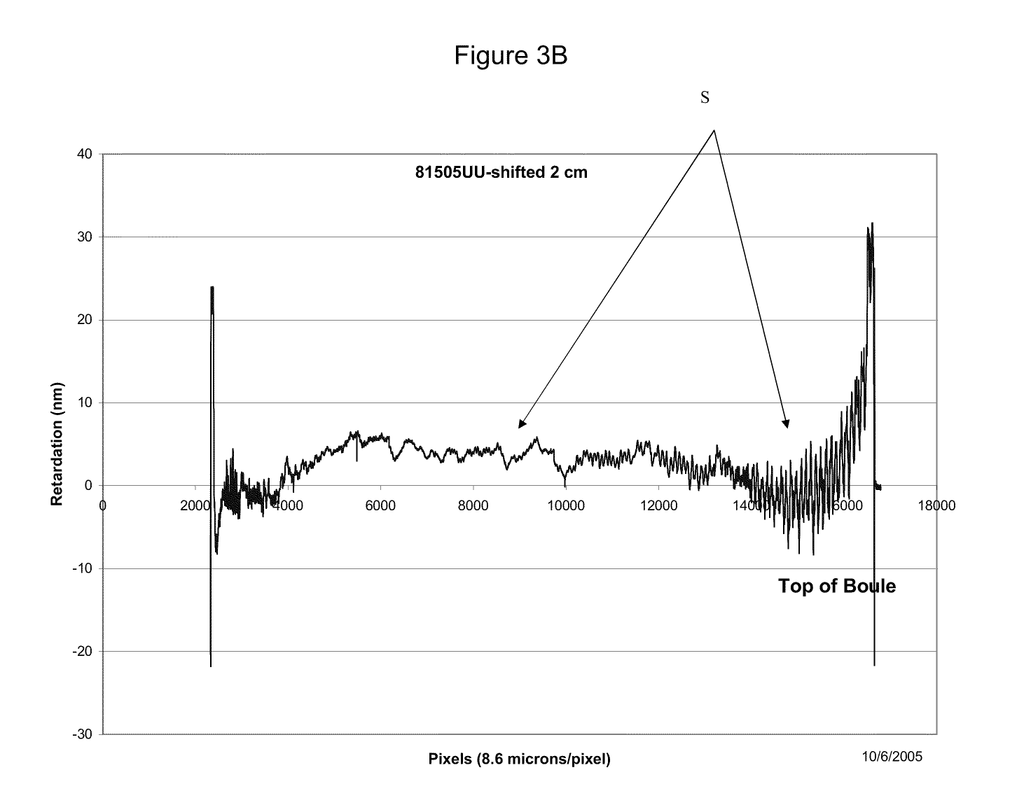

FIGS. 3A and 3B together illustrate the changes in optical retardation due to striae reduction as a result of heat treatment according to the invention. FIG. 3A illustrates the before heat treatment magnitude of optical retardation due to striae (“S”) on the y-axis versus the position of the boule (x-axis). FIG. 3B illustrates the after heat treatment magnitude of optical retardation of the striae S on the y-axis versus the position of the boule (x-axis). In FIG. 3B the elevated optical retardation levels at either end of the graph are not striae, but are a result of sample preparation. A comparison of FIGS. 3A and 3B clearly indicates that there is less optical retardation in the FIG. 3B sample, and this gives a clear indication of striae reduction using the heat treatment according to the invention.

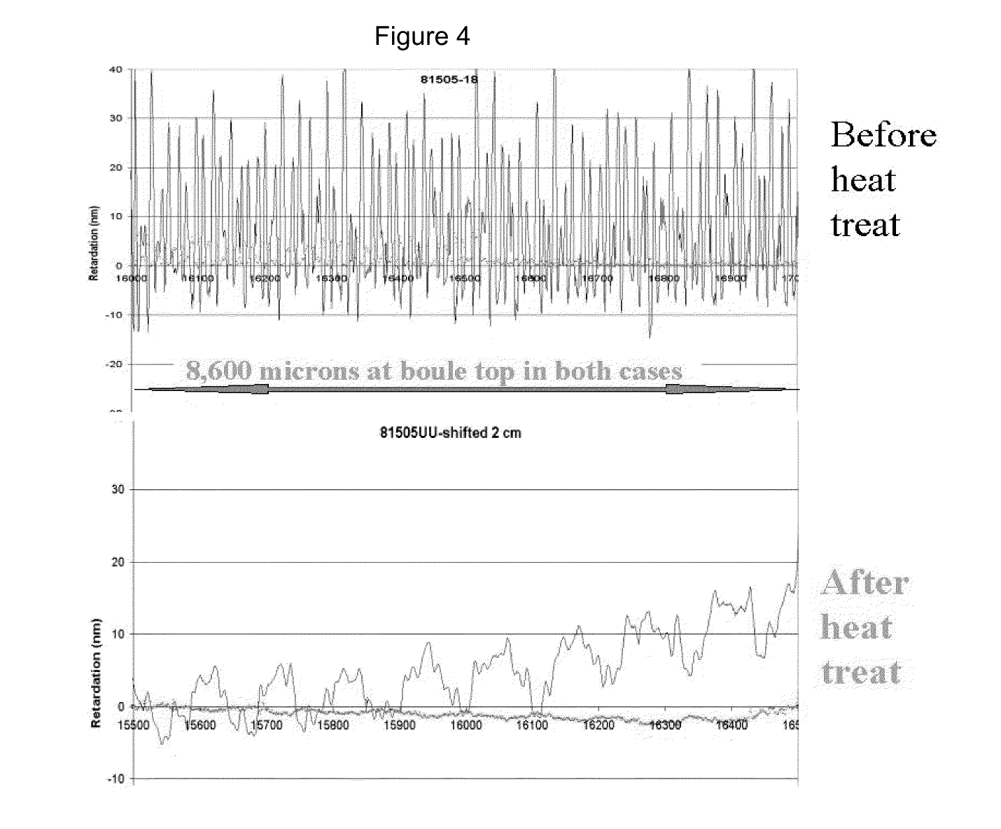

FIG. 4 is another illustration of striae reduction from small sections near the top of a ULE glass boule. This data, and that shown in FIGS. 3A and 3B, indicate that heat treatment according to the invention can reduce the magnitude of striae in a boule by more then 50%. It is also noted that when the invention is practiced most of the “higher frequencies) of striae are eliminated. That is, striae having a retardation value greater than 10 on the vertical scale shown in FIGS. 3A and 3B.

FIG. 5 illustrates CTE (coefficient of thermal expansion) changes versus height in the bole before and after heat treatment according to the invention. The data indicate that the bulk CTE value is not negatively affected by heat treatment according to the invention, and in fact, as illustrated by the point-by-point comparison through the depth of the boule, was reduced after the heat treatment.

### Example 2

A glass boule is prepared according to Example 1, except that during the preparation of the boule the values for ω₁, ω₂ and ω₃ used in the manufacture of the silica-titania boule were each greater than 5 rpm as taught by U.S. 2004/0027555, and the values for ω₁, ω₂ and ω₃ during heat treatment are 1.71018 rpm, 3.63418 rpm and 4.162 rpm, respectively. The resulting boule is then heat treated at a temperature above 1600° C. for a selected time to reduce the striae in the boule. Preferably the boule is heated at a temperature in the range of 1600-1700 for a time in the range 72-160 hours. In a further embodiment of this method the values for ω₁, ω₂ and ω₃ used in the manufacture of the silica-titania boule were each greater than 5 rpm during the heat treatment of the boule according to the present invention to reduce striae.

When practicing striae reduction according to the invention, the cost effective way to reduce striae in a glass boule will be to hold the entire boule at the temperatures and for the times described herein. This can be done at the end of the boule forming process before the boule is removed from the furnace. Using the method of the invention will result in significant striae reduction in all regions of the boule and especially in the top half of the boule. The resulting material can then be processed into an optical blank, for example by coring and/or cutting the boule into segments of a size suitable for forming a desired optical blank, followed by further process steps, including grinding and polishing steps using methods known in the art, to yield optical elements meeting the stringent requirement for optical elements that will be use in ULE applications. For very large elements such as astronomical telescope mirrors the entire boule can be processed into the desired large element.

Having set forth the details of the invention, one can clearly see that by using the method of the invention it is possible to reduce striae in an ultra-low expansion or ultra (ULE) glass. The glass can be prepared in any shape by any method known in the art, and after preparation of the glass it is heat treated in a furnace at a temperature greater than 1600° C. for a time in the range of 72-288 hours and cooled the glass to ambient temperature to yield a silica-titania glass having reduced striae. The most common shape for preparing the glass is a boule that is round and has a thickness, though other shapes are possible.

While the invention has been described with respect to a limited number of embodiments, those skilled in the art, having benefit of this disclosure, will appreciate that other embodiments can be devised which do not depart from the scope of the invention as disclosed herein. For example, while this specification describes heat treating a glass boule that has a diameter and a thickness, or glass cores taken from a boule, a glass of any shape having a thickness can be treated according to the invention. For example, the glass can be rectangular, square, octagonal, hexagonal, oblate, and any other shape known in the art. Accordingly, the scope of the invention should be limited only by the attached claims.

We claim:

1. A method for reducing striae in a silica-titania glass, said method comprising:
supplying a silicon-containing feedstock and a titanium-containing feedstock to at least one burner and combusting the feedstocks to form a silica-titania soot, and, substantially simultaneously, collecting the silica-titania soot in a collection vessel at consolidation temperatures to thereby form a silica-titania glass as the soot is deposited in the vessel;
continuing the collection and consolidation of the silica-titania soot to form a glass boule of selected dimensions;
after collection and consolidation is completed, in a separate step heat treating the glass in a furnace at a temperature greater than 1600° C. for a time in the range of 72-288 hours; and
cooling the glass to ambient temperature to yield a silica-titania glass having reduced striae.

2. The method according to claim 1, wherein the separate heat treating time is in the range of 72-160 hours.

3. The method according to claim 1, wherein the heat treating is carried out without forcing the glass to flow by placing the glass in a vessel and placing a packing material between the glass and the vessel prior to heat treating.

4. The method according to claim 1, wherein after heat treating the glass, the glass is cooled at a rate of approximately 50° C. per hour to a temperature of 1000° C. and then cooled to ambient temperature at the furnace's natural cooling rate.

5. The method according to claim 1, wherein the silica-titania glass is prepared by flame hydrolysis using silica and titania precursors selected from the group consisting of siloxanes and alkoxides and tetrachlorides of silicon and titanium.

6. The method according to claim 5, wherein the precursors are titanium isopropoxide and octamethylcyclotetrasiloxane.

7. The method according to claim 1, wherein the silica-titania soot is collected in a rotating collection vessel and the values for ω₁, ω₂ and ω₃ used in the manufacture of the silica-titania glass boule and for the glass boule during heat treatment at 1600-1700° C. are 1.71018 rpm, 3.63418 rpm and 4.162 rpm, respectively.

8. The method according to claim 1, wherein the silica-titania soot is collected in a rotating collection vessel and the values for ω₁, ω₂ and ω₃ used in the manufacture of the silica-titania boule are each greater then 5 rpm, and the values for ω₁, ω₂ and ω₃ during heat treatment at 1600-1700° C. are 1.71018 rpm, 3.63418 rpm and 4.162 rpm, respectively.

9. The method according to claim 8, wherein the values for ω₁, ω₂ and ω₃ during heat treatment are each greater then 5 rpm.

10. A method for making silica-titania glass optical blanks and/or elements having reduced striae, said method comprising:
supplying a silicon-containing feed stock and a titanium-containing feedstock to burner and combusting the feedstocks to form a silica-titania soot and, substantially simultaneously, collecting the silica-titania soot in a collection vessel at consolidation temperatures to thereby form a silica-titania glass as the soot is deposited in the vessel;
continuing the collection and consolidation of the silica-titania soot to form a glass boule of selected dimensions;
after collection and consolidation is completed, in a separate step heat treating the glass in a furnace at a temperature greater than 1600° C. for a time in the range of 72-160±8 hours;
cooling the glass to ambient temperature to yield a silica-titania glass having reduced striae; and
processing the glass as necessary into a silica-titania glass optical blank and/or element;
wherein the glass of said element contains 5-10 wt. % titania.

11. The method according to claim 13, wherein said glass is heat treated at a temperature in the range of 1600-1700° C. for a time in the range of 72-96±8 hours, and
is cooled from the 1600-1700° C. range to 1000° C. at a rate of 50° C. per hour followed by cooling to ambient temperature at the natural cooling rate of the furnace.

12. A method for making a glass optical element having reduced striae, said method comprising the steps of:
supplying a silicon-containing feed stock and a titanium-containing feedstock to burner and combusting the feedstocks to form a silica-titania soot and, substantially simultaneously, collecting the silica-titania soot in a collection vessel at consolidation temperatures to thereby form a silica-titania glass as the soot is deposited in the vessel;
continuing the collection and consolidation of the silica-titania soot to form a glass boule of selected dimensions;
after collection and consolidation is completed, in a separate step heat treating the glass in a furnace at a temperature greater than 1600° C. for a time in the range of 72-160±8 hours;
cooling the boule from the 1600-1700° C. range to 1000° C. at a rate of 50° C. per hour followed by cooling to ambient temperature at the natural cooling rate of the furnace to thereby yield a silica-titania glass boule having reduced striae;
processing the boule or segments thereof into the shape of a selected optical element; and
cutting, grinding and polishing the shape into an optical element having reduced striae suitable for extreme ultraviolet lithography.

13. The method according to claim 15 wherein the silica-titania glass boule is prepared by flame hydrolysis using silica and titania precursors selected from the group consisting of siloxanes and alkoxides and tetrachlorides of silicon and titanium.
